(19) United States
(12) Patent Application Publication
(10) Pub. No.: US 2002/0181893 A1
(43) Pub. Date: Dec. 5, 2002

(54) Strain relief boot assembly for optical fibers

(76) Inventors: James White, Warwick, RI (US); Brian Records, Wakefield, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/077,528

(22) Filed: Feb. 15, 2002

Related U.S. Application Data
(60) Provisional application No. 60/269,529, filed on Feb. 16, 2001.

(51) Int. Cl. G02B 6/36

(52) U.S. Cl. 385/86; 385/87

(57) ABSTRACT

A strain relief assembly is provided for use in management of optical fibers that enter and exit the enclosure walls of optical fiber components, such as optical amplifiers, etc. The strain relief assembly includes a rigid plastic sleeve, and an elastomeric boot. The boot includes a main body portion having retaining shoulders located on opposing sides of a retaining channel, and further includes a cone-shaped tip portion to guide and support the optical fiber as it exits the wall of the enclosure. The retaining shoulders and retaining channel cooperate to lock the boot into a U-shaped opening in a wall of an enclosure. The main body portion of the boot includes an axial opening for receiving the sleeve and the cone-shaped tip portion includes an co-axially extending bore for receiving the optical fiber. The sleeve is a cylindrical rigid tube configured for receiving the optical fiber therethrough. In use, the fiber is fixed in place inside the sleeve with a UV curable resin. To facilitate the use of such UV curable resins, the sleeve is made of optically transparent material and the boot also includes a window to allow UV light to pass through the boot to the sleeve.

### BACKGROUND AND SUMMARY OF THE INVENTION

The instant invention relates to the manufacture of fiber optic components and amplifiers and more particularly to the management and handling of optical fibers that enter and exit the enclosure walls of fiber optic components.

Optical fibers that enter or exit the housing or enclosure of an optical fiber component need to be supported and protected from stress and strain of normal movement and manipulation of the fiber during handling of the component. In this regard, it has been known in the prior art to utilize an elastomeric boot structure to hold the fiber in place. The prior art primarily consists of a cone-shaped rubber boot that is glued to the outside of the housing. The existing boot is difficult to manipulate, difficult to glue and does not provide proper strain relief. Even further, the boot does not provide a particularly appealing aesthetic appearance, and is difficult to remove in the event of a change in the component or for service to replace the fiber.

Accordingly there is a need in the manufacture of fiber optic components for an improved strain relief boot assembly to better protect the optical fiber and to facilitate assembly.

The instant invention provides a strain relief boot assembly comprising an interior rigid plastic sleeve, and an exterior rubber boot. The rubber boot is preferably made of a polypropylene based elastomer, such as Sarlink™ (Sarlink is a registered trademark of DSM Thermoplastic Elastomers, Inc.). The boot includes a main body portion having stop shoulders located on opposing sides of a generally circular retaining channel, and further includes a cone-shaped tip portion to guide and support the optical fiber as it exits the wall of the enclosure. The stop shoulders and retaining channel cooperate to lock the boot into a U-shaped opening in a wall of an enclosure. The main body portion of the boot includes an axial opening for receiving the internal sleeve and the cone-shaped tip portion includes an axially extending bore for receiving the optical fiber. The sleeve is generally a cylindrical rigid tube configured for receiving the optical fiber therein. In use, the fiber is glued in place inside the sleeve to fix the position of the fiber relative to the sleeve. The sleeve further includes a centrally located external shoulder, and an end shoulder. Upon assembly, the tubular sleeve is inserted into the internal axial opening where the central shoulder is received into the interior of the opening and mated with a corresponding locking groove on the inside of the opening. The mated shoulder and groove restrict axial movement of the sleeve with respect to the boot. The end shoulder remains exposed outside the end surface of the base of the boot. The sleeve is preferably made of optically transparent or translucent plastic material, such as Lexan™ (Lexan is a registered trademark of General Electric Corporation). The sleeve is transparent or translucent to facilitate the use of UV curable resins for gluing or affixing the fiber within the sleeve. Furthermore, the top face of the main body portion of the boot includes a window so that the sleeve is visible externally of the boot. This window further facilitates the use of UV curable resins in fixing of the fiber, as it allows the entire boot to be assembled in position, and then the fiber can be fixed in place within the boot by exposing the entire assembly to UV light which will pass through the window in the boot, and into the exposed end of the sleeve to impinge on the resin disposed inside.

The overall size, as well as channel width and diameter, could be revised to fit fibers of different diameters and housing thicknesses.

Accordingly, among the objects of the instant invention are: the provision of a high-quality, professional-looking, functional boot that relieves strain on optical fibers, shortens production time, and makes installation easier; and the provision of a universal boot that can be used on many different types of optical fiber components.

Other objects, features and advantages of the invention shall become apparent as the description thereof proceeds when considered in connection with the accompanying illustrative drawing.

### DESCRIPTION OF THE DRAWINGS

In the drawings which illustrate the best mode presently contemplated for carrying out the present invention:

FIG. 1 is an assembled perspective view of the optical fiber strain relief boot of the present invention;

FIG. 2 is a top view thereof;

FIG. 3 is a cross-sectional view thereof as taken along line 3-3 of FIG. 2;

FIG. 4 is a side view thereof;

FIG. 5 is a cross-sectional view thereof as taken along line 5-5 of FIG. 4 and also showing the optical fiber passing therethrough;

FIG. 6 is a top view of the sleeve, the top, bottom and both sides being the same;

FIG. 7 is a perspective view thereof;

FIG. 8 is a perspective view of the elastomeric boot;

FIG. 9 is a side view thereof;

FIG. 10 is a top view thereof; and

FIG. 11 is a perspective assembly view of the strain relief boot of the present invention mounted in the wall of an enclosure.

### DESCRIPTION OF THE PREFERRED EMBODIMENT

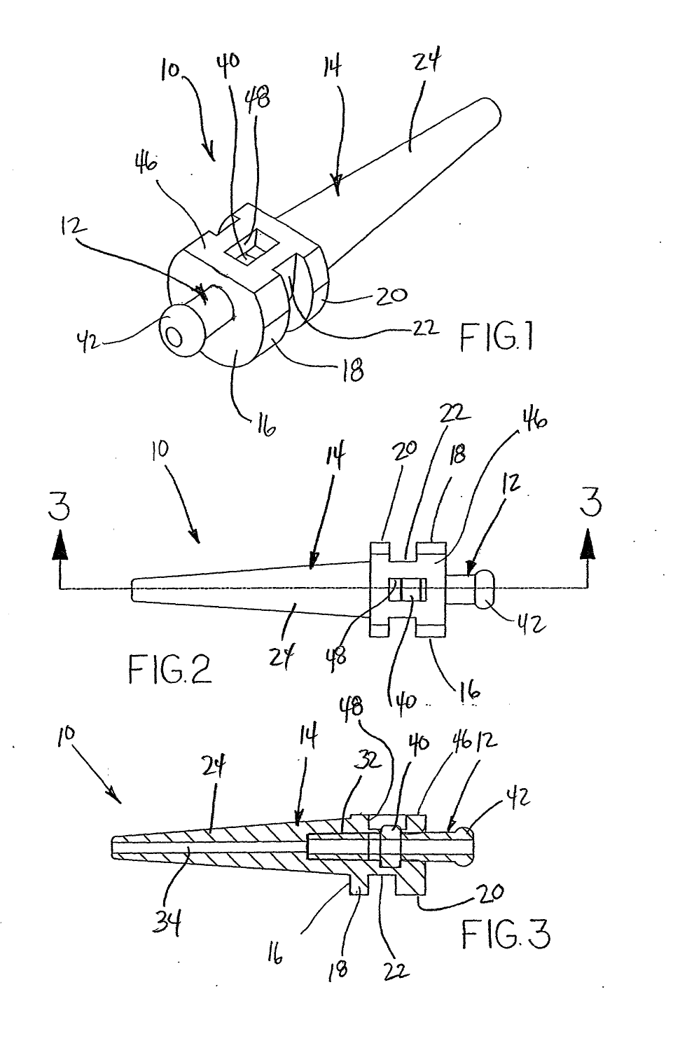

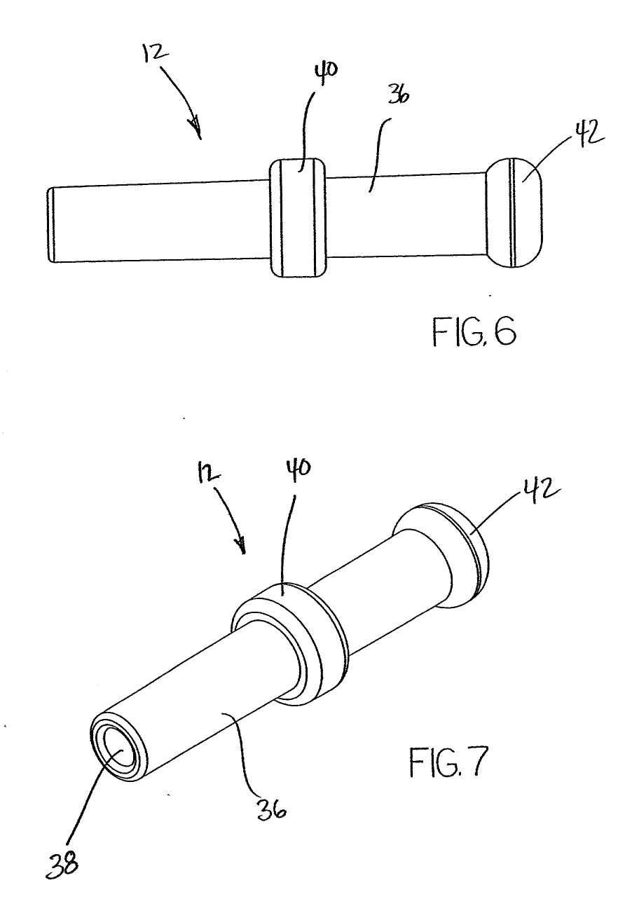

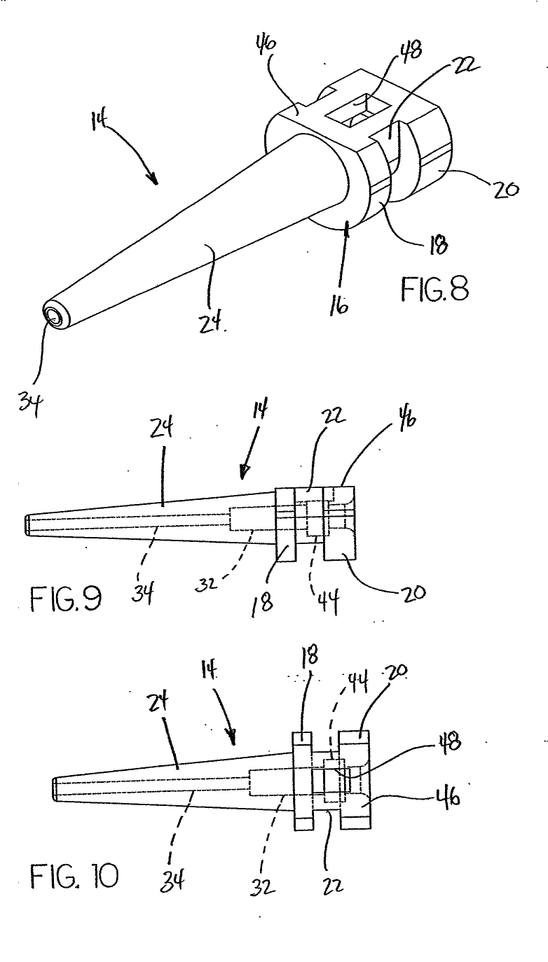

Referring now to the drawings, the strain relief boot assembly of the instant invention is illustrated and generally indicated at 10 in FIGS. 1-11. As will hereinafter be more fully described, the instant strain relief boot assembly provides a high-quality, professional-looking, functional strain relief boot assembly that relieves strain on optical fibers, shortens production time, and makes installation and service of the fiber easier.

The strain relief boot assembly 10 comprises an interior rigid plastic sleeve generally indicated at 12, and an exterior rubber boot generally indicated at 14.

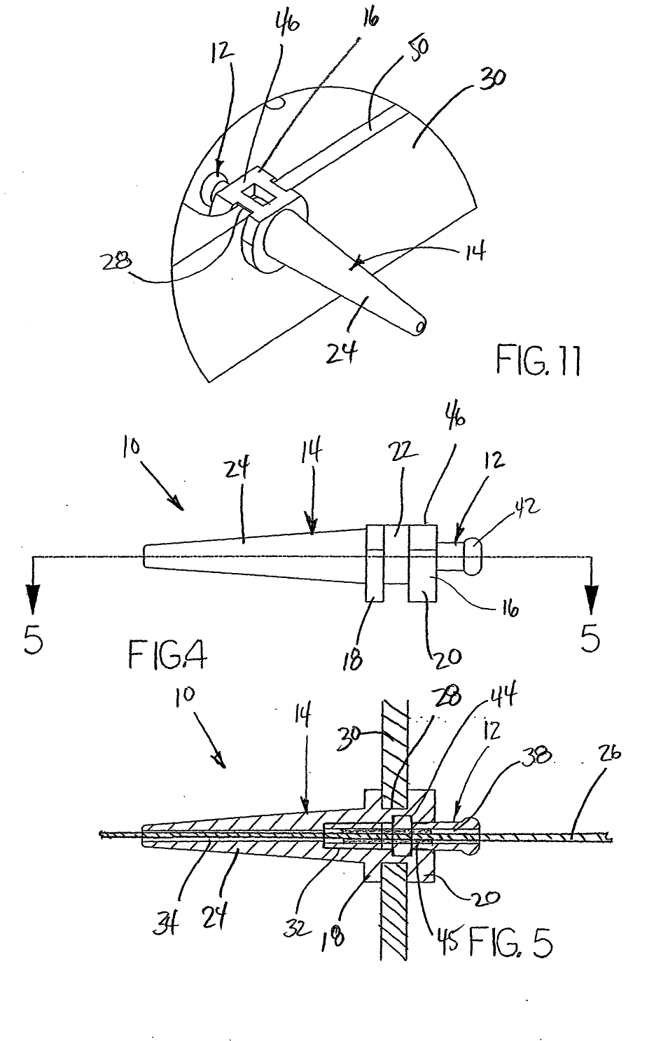

The rubber boot 14 is preferably made of a polypropylene based elastomer, such as Sarlink™ (Sarlink is a registered trademark of DSM Thermoplastic Elastomers, Inc.). The preferred elastomer has a durometer of about 4370. However, it should be understood within the scope of the invention that other elastomeric materials are also suitable and could be used in the place of Sarlink™ with similar results. The boot 14 includes a main body portion 16 having stop shoulders 18, 20 located on opposing sides of a generally U-Shaped retaining channel 22, and further includes a cone-shaped tip portion 24 which functions to guide and support the optical fiber 26 as it exits the wall of an enclosure. The stop shoulders 18, 20 and retaining channel 22 cooperate to lock the boot 14 into a U-shaped slot 28 formed in the peripheral edge of a wall 30 of an enclosure (See FIG. 11). The main body portion 14 of the boot 12 further includes an axial opening 32 (best shown in broken lines in FIGS. 9 and 10) for receiving the sleeve 12. It is also noted here that the cone-shaped tip portion 24 includes an axially extending bore 34 (also best seen in broken line in FIGS. 9 and 10), co-axial with the axial opening 23, for receiving the optical fiber 25 therethrough (best seen in FIG. 5).

The sleeve 12 is generally a cylindrical, rigid tube 36 having an axial opening 38 configured for receiving the optical fiber 26 therein. In use, the fiber 26 will be glued in place inside the sleeve 12 to fix the position of the fiber 26 relative to the sleeve 12 (See FIG. 5). The sleeve 12 further includes a radially outwardly extending, centrally-located, external shoulder 40, and another external shoulder 42 located at the second end thereof. Upon assembly, the first end of the tubular sleeve 12 is inserted into the axial opening 32 where the central shoulder 40 is mated with a corresponding locking groove 44 on the inside of the opening 32. The mated shoulder 42 and locking groove 44 restrict axial movement of the sleeve 12 with respect to the boot 14. The end shoulder 42 remains exposed outside the end surface of the main body portion 16 of the boot 14.

The sleeve 12 is preferably made of optically transparent or translucent plastic material, such as Lexan™ plastic (Lexan is a registered trademark of General Electric Corporation). The sleeve 12 is preferably transparent or translucent to facilitate the use of a UV curable resin or adhesive 45 (FIG. 5) for gluing or affixing the optical fiber 26 within the sleeve 12. In this regard, it should also be understood within the scope of the invention that other optically transparent or translucent plastic materials could also be used in the place of Lexan™ with similar results.

To further facilitate the use of UV curable adhesives or resins 45, a substantially planar top surface 46 of the main body portion 16 of the boot 14 includes a radially inwardly extending window 48 communicating with the locking groove 44 of axial opening 32 so that the sleeve 12 is visible externally of the boot 14. As indicated above, this window 48 further facilitates the use of UV curable resins 45 in fixing of the fiber 26, as it allows the entire boot assembly 10 to be placed in position before fixing of the fiber 26. The fiber 26 can be fixed in place in position, within the boot assembly 10 by exposing the entire assembly 10 to UV light which will pass through the window 48 in the boot 14 into the surface of the sleeve 12, as well as into the exposed second end of the sleeve 12 to impinge on the resin 45 disposed inside.

Referring again to FIGS. 5 and 11, there is shown an assembly of an optical fiber 26 within the strain relief boot assembly 10. In a method of assembly, the sleeve 12 is first assembled with the optical fiber 26 and the sleeve 12 is located at a desired position along the length of the optical fiber 26. In order to fix the fiber 26 within the sleeve 12, a fixing agent 45, such as glue, or more preferably an ultra-violet (UV) light curable resin 45 is disposed within the interior of the sleeve 12. Glues and UV curable resins for use with optical fibers are well known in the art, and further details therefore are not believed to be necessary for an understanding of the invention. Thereafter, the boot 14 can be assembled with the sleeve 12 by inserting the first end of the sleeve 12 into the axial opening 32 wherein the central shoulder 40 of the sleeve 12 snaps into position in the internal locking groove 44. The boot 14 can then be secured into the wall 30 of the enclosure by sliding the retaining channel 22 downwardly into the complementary slot 28 formed in the peripheral edge of the enclosure wall 30.

Fixing of the optical fiber 26 within the sleeve 12 can occur at several different stages of assembly.

The fiber 26 can be fixed immediately within the sleeve 12 upon assembly. Alternatively, the fiber 26 could be fixed in position after the boot 14 and sleeve 12 are assembled together, or even further, the fiber 26 could be fixed in position after final assembly of the boot assembly 10 with the wall 30 of the enclosure. The clear plastic sleeve 12 and the window 48 in the top of the boot 14 facilitate exposure of the UV curable resin at any point during assembly.

It is also noted that it is preferable to align the planar surface 46 of the main body portion 16 of the boot 14 with the peripheral edge 50 of the enclosure wall 30 to form a continuous flat edge along the peripheral edge 50 of the wall 30. In this regard, when a top cover (not shown) of the enclosure is assembled with the wall 30, the top cover presses against the planar surface 46 of the boot 16 holding the boot 14 in place without the use of any adhesive between the boot 14 and the enclosure wall 30. This is a significant improvement in assembly, and more particularly, is a significant improvement with regard to service and repair, since the boot 14 can be easily removed from the enclosure after removing the cover of the enclosure, and further can be removed from the sleeve 12.

The strain relief boot assembly 10 of the present invention is primarily designed for use with 900 micron jacketed optical fibers, i.e. single strand jacketed optical fibers. However, the overall size, as well as channel width and diameter, could be revised to fit fibers of different diameters and housing thicknesses.

It can therefore be seen that the present invention provides a high-quality, professional-looking, functional strain relief boot assembly 10 that relieves strain on optical fibers, shortens production time, and makes installation and service of the fiber easier. For these reasons, the instant invention is believed to represent a significant advancement in the art which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A strain relief device for an optical fiber comprising:
a rigid tubular sleeve configured to receive therethrough a length of optical fiber, said sleeve having a radially outwardly extending shoulder located between first and second ends thereof; and
an elastomeric boot having a main body portion and a conical tip portion, said main body portion including spaced retaining shoulders that define a retaining groove, said retaining groove being configured to be received in a complementary opening formed in a wall of an enclosure, said main body portion further including an axial opening configured to receive at least a portion of said first end of said sleeve, said shoulder on said sleeve being received in a complementary locking groove formed in said axial opening, said conical tip portion including a bore co-axial with said axial opening and configured to receive said length of optical fiber when said sleeve is received in assembled relation with said boot.

2. The strain relief device of claim 1 wherein said sleeve is constructed from an optically translucent material.

3. The strain relief device of claim 2 wherein said sleeve is constructed from a substantially optically transparent material.

4. The strain relief device of claim 1 wherein said main body portion of said boot has an upper side and a lower side and said upper side is configured with a substantially planar surface.

5. The strain relief device of claim 2 wherein said main body portion includes a radially inwardly extending window configured to allow light to impinge upon said sleeve when said sleeve is received in assembled relation within said boot.

6. The strain relief device of claim 4 wherein said planar surface of said main body portion includes a radially inwardly extending window configured to allow light to impinge upon said sleeve when said sleeve is received in assembled relation within said boot.

7. The strain relief device of claim 1 wherein said elastomeric boot is formed from an elastomeric material having a durometer of about 4370.

8. A fiber optic component comprising:
an enclosure having a wall, said wall having a slot extending inwardly from a peripheral edge thereof;
a length of optical fiber extending through said slot;
a strain relief device disposed within said slot, said strain relief device receiving said optical fiber therethrough, said strain relief device comprising
a rigid tubular sleeve configured to receive therethrough said length of optical fiber, said sleeve having a radially outwardly extending shoulder located between first and second ends thereof, and
an elastomeric boot having a main body portion and a conical tip portion, said main body portion including spaced retaining shoulders that define a retaining groove, said retaining groove being configured to be received in a complementary slot formed in a wall of an enclosure, said main body portion further including an axial opening configured to receive at least a portion of said first end of said sleeve, said shoulder on said sleeve being received in a complementary locking groove formed in said axial opening, said conical tip portion including a bore co-axial with said axial opening and configured to receive said length of optical fiber when said sleeve is received in assembled relation with said boot; and
a fixing agent disposed within said sleeve for fixing said length of optical fiber in position relative to said sleeve.

9. The fiber optic component of claim 8 wherein said sleeve is constructed from an optically translucent material, and said fixing agent is a ultra-violet (UV) light curable resin.

10. The fiber optic component of claim 9 wherein said sleeve is constructed from a substantially optically transparent material.

11. The fiber optic component of claim 8 wherein said main body portion of said boot has an upper side and a lower side and said upper side is configured with a substantially planar surface.

12. The fiber optic component of claim 9 wherein said main body portion includes a radially inwardly extending window configured to allow said UV light to impinge upon said sleeve when said sleeve is received in assembled relation within said boot.

13. The fiber optic component of claim 12 wherein said planar surface of said main body portion includes a radially inwardly extending window configured to allow said UV light to impinge upon said sleeve when said sleeve is received in assembled relation within said boot.

14. The fiber optic component of claim 8 wherein said elastomeric boot is formed from an elastomeric material having a durometer of about 4370.

15. A method of assembling a strain relief device with an optical fiber comprising the steps of:
providing a length of optical fiber;
providing a strain relief device configured to receive said optical fiber therethrough, said strain relief device comprising
a rigid tubular sleeve configured to receive therethrough said length of optical fiber, said sleeve having a radially outwardly extending shoulder located between first and second ends thereof, and
an elastomeric boot having a main body portion and a conical tip portion, said main body portion including spaced retaining shoulders that define a retaining groove, said retaining groove being configured to be received in a complementary opening formed in a wall of an enclosure, said main body portion further including an axial opening configured to receive at least a portion of said first end of said sleeve, said shoulder on said sleeve being received in a complementary locking groove formed in said axial opening, said conical tip portion including a bore co-axial with said opening and configured to receive said length of optical fiber when said sleeve is received in assembled relation with said boot;
extending said fiber through said sleeve; and
extending said fiber through said boot and inserting said first end of said sleeve into said axial opening in said boot.

16. The method of claim 15 wherein said sleeve is formed from an optically translucent material.

17. The method of claim 16 wherein said sleeve is constructed from a substantially optically transparent material.

18. The method of claim 15 further comprising the step of fixing said optical fiber within said sleeve.

19. The method of claim 16 further comprising the step of fixing sad optical fiber within said sleeve.

20. The method of claim 19 wherein said step of fixing said optical fiber comprising the steps of:
disposing a ultra-violet (UV) light curable fixing agent within said sleeve; and
exposing said sleeve to a UV light source wherein said UV light curable fixing agent hardens to fix said optical fiber relative to said sleeve.

21. The method of claim 15 wherein said main body portion of said boot has an upper side and a lower side and said upper side is configured with a substantially planar surface.

22. The method of claim 20 wherein said main body portion of said boot includes a radially inwardly extending window configured to allow said UV light to impinge upon said sleeve when said sleeve is received in assembled relation within said boot, and further wherein said boot is assembled with said sleeve prior to exposing said UV curable fixing agent to said UV light source.
